(19) United States
(12) Patent Application Publication
(10) Pub. No.: US 2008/0122753 A1
(43) Pub. Date: May 29, 2008

(54) Plasma display and driving method thereof

(76) Inventors: Tae-Seong Kim, Suwon-si (KR); Seung-Won Choi, Suwon-si (KR); Seong-Joon Jeong, Suwon-si (KR); Woo-Joon Chung, Suwon-si (KR)

Correspondence Address: ROBERT E. BUSHNELL, 1522 K STREET NW, SUITE 300, WASHINGTON, DC, 20005-1202, US

(21) Appl. No.: 11/976,328

(22) Filed: Oct. 23, 2007

(30) Foreign Application Priority Data
Nov. 23, 2006 (KR) 10-2006-0116416

(51) Int. Cl. G09G 3/28

(52) U.S. Cl. 345/67

(57) ABSTRACT

In a plasma display device, an elapsed driving time of the plasma display device is accumulated and calculated, and a scan pulse having a first voltage is supplied to a scan electrode during a first period which is an address period of each subfield in response to the accumulated driving time being less than a reference time, and a scan pulse having a second voltage that is greater than the first voltage is supplied to a scan electrode during a second period which is an address period of each subfield in response to the accumulated driving time being greater than the reference time.

### CLAIM OF PRIORITY

This application makes reference to, incorporates the same herein, and claims all benefits accruing under 35 U.S.C.§119 from an application for PLASMA DISPLAY AND DRIVING METHOD THEREOF earlier filed in the Korean Intellectual Property Office on the 23 Nov. 2006 and there duly assigned Serial No. 10-2006-0116416.

### BACKGROUND OF THE INVENTION

1. Field of the Invention

The present invention relates to a plasma display device and a driving method thereof.

2. Description of the Related Art

A plasma display device is a flat panel display that uses a plasma generated by a gas discharge to display characters or image, and it includes, depending on its size, more than several scores to millions of pixels arranged in a matrix format.

Generally, in a plasma display device, a field (e.g., 1 TV field) is divided into respectively weighted subfields, and each subfield includes a reset period, an address period, and a sustain period with respect to time.

The reset period is for initializing the status of each discharge cell so as to facilitate an addressing operation on the discharge cell, and the address period is for selecting turn-on/turn-off cells (i.e. cells to be turned on or off) and accumulating wall charges to the turn-on cells (i.e. addressed cells) by supplying an address voltage thereto. The sustain period is for causing a discharge for displaying an image on the addressed cells.

During the address period, a sustain pulse having a VscL voltage is sequentially supplied to a plurality of scan electrode pulses to select turn-on discharge cells. An address pulse having a Va voltage is supplied to an address electrode passing through the selected discharge cells having scan electrodes to which the VscL voltage has been supplied. Then, a discharge firing voltage Vfay is generated between the scan electrodes supplied with the VscL voltage and the address electrode supplied with the Va voltage and thus an address discharge is generated. Due to the address discharge, positive (+) wall charges are formed on the scan electrodes and negative (−) wall charges are formed on the address and sustain electrodes. An address electrode that passes through turned-off discharge cells is supplied with a reference voltage (e.g., 0V).

However, characteristics of an MgO layer of the plasma display device vary depending on an accumulation of elapsed driving time of the plasma display device, causing a decrease of the discharge firing voltage. Therefore, when the elapsed driving time of the plasma display device exceeds a predetermined elapsed driving time, and the address electrode that passes through the turned-off discharge cells is supplied with the reference voltage (0V) and the scan electrode is supplied with the VscL voltage, the discharge firing voltage Vfay is decreased, thereby causing a discharge of the turned-off discharge cells. Such a discharge error of the address discharge causes misfiring in the sustain period.

### SUMMARY OF THE INVENTION

The present invention has been made in an effort to provide a plasma display device having advantages of performing a stable discharge without regarding its elapsed driving time, and a driving method thereof.

A driving method according to an embodiment of the present invention drives a plasma display device by a plurality of weighted subfields divided from a frame. The plasma display device has a first electrode, a second electrode, and a third electrode arranged in a direction that crosses the first and second electrodes. The driving method includes: calculating a driving time of the plasma display device by accumulating the driving time; comparing the accumulated driving time with a predetermined reference time; and supplying a sustain pulse having a first voltage to the first electrode during a first period which is an address period of each subfield in response to the accumulated driving time being less than the reference timer, and supplying a sustain pulse having a second voltage that is greater than the first voltage to the first electrode during a second period which is an address period of each subfield in response to the accumulated driving time being greater than the reference time.

A plasma display device according to another embodiment of the present invention includes a Plasma Display Panel (PDP), a driver, and a controller, and the plasma display device is driven by a plurality of subfields divided from a frame. The PDP has a plurality of first electrodes, a plurality of second electrode, a plurality of third electrodes arranged to cross the first and second electrodes, and a plurality of discharge cells including the first and second electrodes. The driver supplies a scan pulse and an address pulse to the discharge cells for an address discharge in the plurality of subfields. The controller accumulates an elapsed driving time of the PDP and calculates an accumulated driving time, controls a sustain pulse having a first voltage to be supplied to the first electrode during a first period which is an address period of each subfield in response to the accumulated driving time being less than a predetermined reference time, and controls a sustain pulse having a second voltage that is greater than the first voltage to be supplied to the first electrode during a second period which is an address period of each subfield in response to the accumulated driving time being greater than the reference time.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display device according to an exemplary embodiment of the present invention.

FIG. 2 is a flowchart of the operation of the controller of FIG. 1.

FIG. 3 includes driving waveforms of a plasma display device according to a first exemplary embodiment of the present invention.

FIG. 4 includes driving waveforms of a method of driving a plasma display device according to a second exemplary embodiment of the present invention.

### DETAILED DESCRIPTION OF THE INVENTION

Exemplary embodiments of the present invention are described in detail below with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

Like reference numerals designate like elements throughout the specification. In addition, throughout this specification and claims which follow, unless explicitly described to the contrary, the word “comprise/include” or variations such as “comprises/includes” or “comprising/including” will be understood to imply the inclusion of stated elements but not the exclusion of any other elements.

Wall charges mentioned in the following description mean charges formed and accumulated on a wall (e.g., a dielectric layer) close to an electrode of a discharge cell. In addition, although the wall charges do not actually touch the electrodes, the wall charge will be described as being “formed” or “accumulated” on the electrode. Furthermore, a wall voltage means a potential difference formed on the wall of the discharge cell by the wall charge.

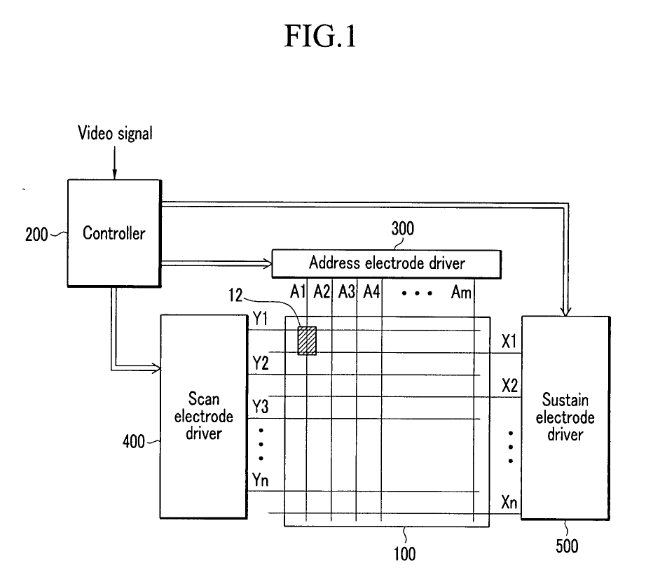

FIG. 1 is a block diagram of a plasma display device according to an exemplary embodiment of the present invention.

As shown in FIG. 1, the plasma display device includes a Plasma Display Panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and scan electrodes Y1 to Yn extending in a row direction by pairs. The sustain electrodes X1 to Xn respectively correspond to the scan electrodes Y1 to Yn, and the sustain electrodes X1 to Xn and the scan electrodes Y1 to Yn perform a display operation during a sustain period to display an image. The address electrodes A1 to Am are arranged to cross the sustain electrodes X1 to Xn and the scan electrodes Y1 to Yn. A discharge space on a crossing region of the address electrodes A1 to Am and the scan electrodes Y1 to Yn and the sustain electrodes X1 to Xn forms a discharge cell 12. The structure of the PDP 100 is merely exemplary, and panels of other structures can be used in the present invention.

The controller 200 receives an external video signal, outputs an address electrode driving control signal, a sustain electrode driving control signal, and a scan electrode driving control signal. In addition, the controller 200 divides the plasma display device by dividing a frame into a plurality of subfields. Each subfield includes a reset period, an address period, and a sustain period in a temporal manner.

The address driver 300 receives the address electrode driving control signal from the controller 200 and supplies a display data signal to the respective address electrodes so as to select discharge cells to be displayed.

The scan electrode driver 400 receives the scan electrode driving control signal from the controller 200 and supplies a driving voltage to the scan electrodes.

The sustain electrode driver 500 receives the sustain electrode driving control signal from the controller 200 and supplies a driving voltage to the sustain electrodes.

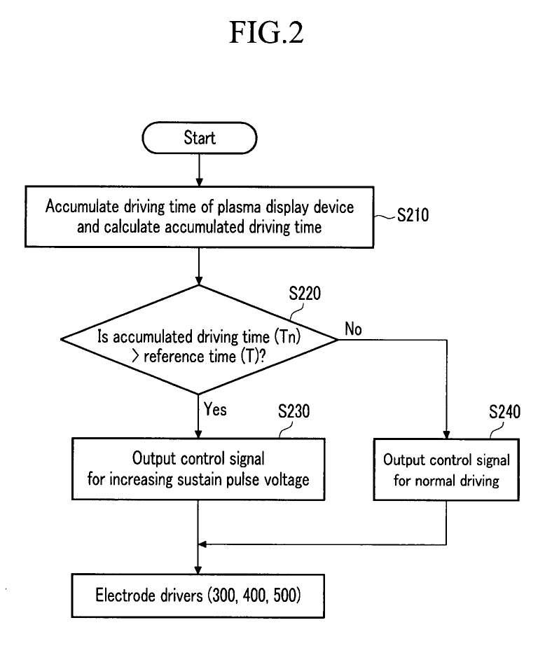

Operation of the controller in the plasma display device according to the exemplary embodiment of the present invention is described in more detail below with reference to FIG. 2.

FIG. 2 is a flowchart of the operation of the controller of FIG. 1. As shown in FIG. 2, the controller 200 accumulates an elapsed driving time of the plasma display device and calculates an accumulated driving time in step S210, and compares the accumulated driving time Tn with a predetermined reference time T in step S220.

When the accumulated driving time Tn is greater than the reference time T, the controller 200 outputs a control signal to the drivers 300, 400, and 500 of the respective electrodes to increase a voltage of the scan pulse supplied to the scan electrodes during the address period in step S230.

When the accumulated driving time Tn is less than the reference time T, the controller 200 outputs a control signal to the drivers 300, 400, and 500 of the respective electrodes to supply a normal driving waveform in step S240.

The normal driving waveform may vary depending on the characteristics of the plasma display panel. For example, in the normal driving waveform, a sustain pulse having a VscL1 voltage is supplied to the scan electrode during the address period. The VscL1 voltage is less by a ΔV1 voltage than a final voltage Vnf supplied to the scan electrode during a falling period of the reset period. However, when the accumulated driving time Tn is greater than the reference time T, the scan electrode is supplied with a sustain pulse having a VscL2 voltage that is greater than the VscL1 voltage in the normal driving waveform. The VscL2 voltage is less by a ΔV2 voltage than the final voltage Vnf supplied to the scan electrode during the falling period of the reset period. The ΔV2 voltage is less than ΔV1 voltage.

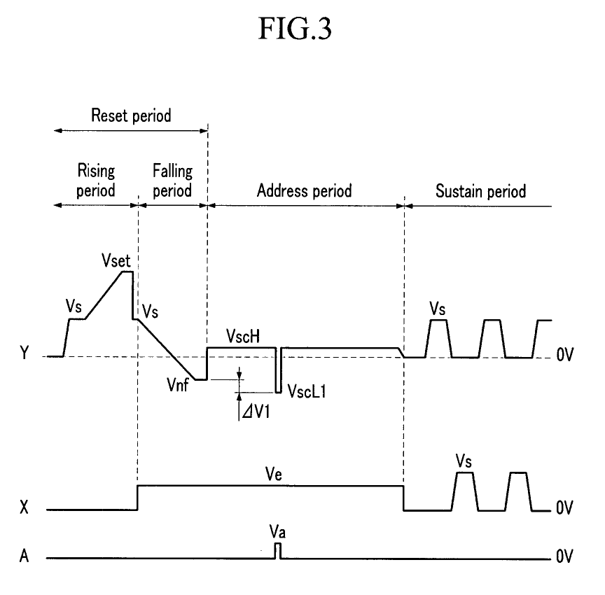

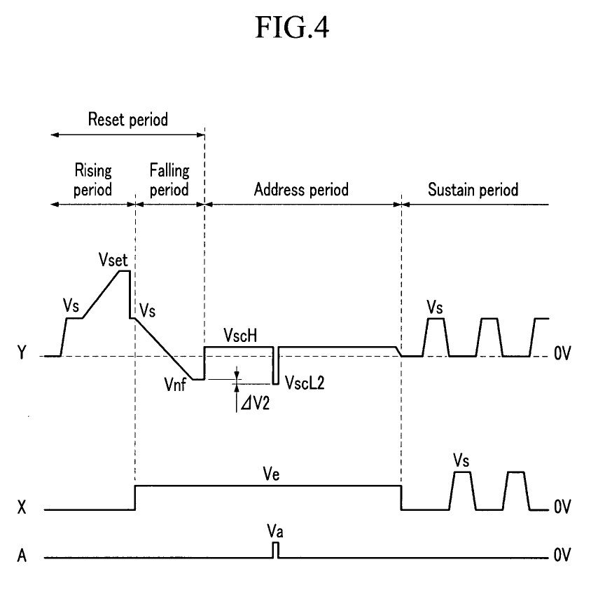

Driving waveforms supplied to the address electrodes A1 to Am, sustain electrodes X1 to Xn, and scan electrodes Y1 to Yn are described in more detail with reference to FIG. 3 and FIG. 4. For better understand and ease of description, the driving waveforms supplied to an address electrode, a sustain electrode X, and a scan electrode Y that form one cell are shown. The address electrode, sustain electrode, and scan electrode will be respectively referred to as an A electrode, an X electrode, and a Y electrode.

FIG. 3 includes driving waveforms of a plasma display device according to a first exemplary embodiment of the present invention.

As shown in FIG. 3, during a rising period of a reset period, voltages of the X and A electrodes are maintained at a reference voltage (i.e., ground voltage of 0V in FIG. 3), and a voltage of the Y electrode is gradually increased from a Vs voltage to a Vset voltage. While the voltage of the Y electrode is gradually increased, a weak discharge occurs between the Y and X electrodes and between Y and A electrodes and negative (−) wall charges are formed on the Y electrode and positive (+) wall charges are formed on the A electrode.

During a falling period of the reset period, the voltage of the Y electrode is gradually decreased from the Vs voltage to a Vnf voltage while the voltages of the A and X electrodes are respectively biased with the reference voltage and a Ve voltage. Then, a weak discharge occurs between the Y and X electrodes and between the Y and A electrodes while the voltage of the Y electrode is gradually decreased, and the negative (−) wall charge formed on the Y electrode and the positive (+) wall charge formed on the A electrode are erased. In general, a (Ve-Vnf) voltage is set close to a discharge firing voltage Vfxy between the Y and X electrodes. Then, a wall voltage between the Y electrode and the X electrode almost becomes 0V such that misfiring in the cells that are not addressed during the address period can be prevented during the sustain period.

The Vs voltage of the Y electrode in the falling period of the reset period may be set a lower voltage than the Vs voltage.

During the address period, a scan pulse having a VscL1 voltage is sequentially supplied to a plurality of Y electrodes while the X electrode is supplied with a Ve voltage so as to select discharge cells to be turned on. A Va voltage is supplied to an A electrode passing through discharge cells to be turned on and having the Y electrode to which the VscL voltage is supplied and the X electrode supplied with the Ve voltage. Then, an address discharge occurs between the A electrode supplied with the Va voltage and the Y electrode supplied with the VscL1 voltage and between the Y electrode supplied with the VscL1 voltage and the X electrode supplied with the Ve voltage. Accordingly, positive (+) wall charges are formed on the Y electrode and negative (−) wall charges are formed on the X electrode. A Y electrode to which the VscL voltage is not supplied is supplied with a VscH voltage that is greater than the VscL1 voltage, and an A electrode of an unselected discharge is supplied with the reference voltage. The VscL1 voltage is less by ΔV1 than a final voltage Vnf supplied to the Y electrode during the falling period of the reset period.

For such an operation in the address period, the scan electrode driver 400 selects a Y electrode from among the Y electrodes Y1 to Yn to be supplied with the scan pulse having the VscL1 voltage. For example, in a single driving scheme, the scan electrode driver 400 may sequentially select Y electrodes arranged in a vertical direction. When one Y electrode is selected, the address electrode driver 300 selects a turn-on discharge cell from among discharge cells having the selected Y electrode. Then, the address electrode driver 300 selects an A electrode from among the A electrodes An to Am to be supplied with an address pulse having the Va voltage.

During the sustain period, a sustain pulse having a high level voltage (i.e., Vs in FIG. 3) and a low level voltage (i.e., 0V in FIG. 3) is supplied to the Y electrode and the X electrode. A sustain pulse phase supplied to the Y electrode is opposite to a sustain pulse phase supplied to the X electrode. Then, the Vs voltage is supplied to the Y electrode and 0V is supplied to the X electrode and a sustain discharge occurs between the Y and X electrode, and a negative wall charge is formed on the Y electrode and a positive wall charge is formed on the X electrode due to the sustain discharge. A process for supplying the sustain pulse to the Y electrode and the X electrode is repeated a number of times corresponding to a weight value of the corresponding subfield. In general, a sustain pulse is a square wave having a Vs sustain period.

As described above, a Y electrode corresponding to a turn-on discharge cell among a plurality of discharge cells is supplied with the VscL1 voltage and an A electrode corresponding to the turn-on discharge is supplied with the Va voltage to cause an address discharge, and accordingly, cells to be sustain-discharged in the sustain period can be stably selected.

However, the discharge firing voltage Vfay is decreased as an elapsed driving time of the plasma display device is accumulated. Therefore, when the accumulated driving time Tn exceeds the reference time T, and the reference voltage is supplied to an A electrode passing through a turn-off discharge cell and the VscL1 voltage is supplied to a Y electrode, the discharge firing voltage Vfay is decreased, thereby causing an address discharge in the turned-off cell. When the address discharge occurs in the turned-off discharge cell during the address period, a sustain period subsequent to the address period experiences a misfiring. In the following description, a method of driving the plasma display device for preventing a misfiring of a sustain discharge that occurs due to accumulation of the driving time of the plasma display device is described in more detail with reference to FIG. 4.

FIG. 4 includes driving waveforms of a method of driving a plasma display device according to a second exemplary embodiment of the present invention.

As shown in FIG. 4, the driving waveforms according to the second embodiment of the present invention are identical to the driving waveforms of the first exemplary embodiment of the present invention, except that the sustain pulse voltage VscL1 supplied to the Y electrode is replaced by a VscL2 voltage in the second exemplary embodiment of the present invention. The VscL2 voltage is greater than the VscL1 voltage, and less by ΔV2 than a final voltage Vnf supplied to the Y electrode during a falling period of a reset period. The ΔV2 voltage is less than the ΔV1 voltage of the first exemplary embodiment of the present invention.

As described above, when an accumulated driving time Tn is greater than a predetermined reference time T, the scan pulse voltage supplied to the Y electrode is increased from the VscL voltage to the VscL2 voltage so as to prevent a turn-off discharge cell from experiencing an address discharge during an address period according to the second exemplary embodiment of the present invention. Then, a voltage difference between the Y electrode and the A electrode is reduced as compared to when the accumulated driving time Tn is less than the reference time T and accordingly, an address discharge does not occur between the Y electrode supplied with the VscL2 voltage and the A electrode supplied with the reference voltage. However, the Y electrode supplied with the VscL2 voltage and the A electrode supplied with the Va voltage experience an address voltage therebetween. That is, in the second exemplary embodiment of the present invention, a turn-on cell can be stably selected during the address period by increasing a sustain pulse voltage supplied to the Y electrode when the accumulated driving time Tn increases. In addition, an occurrence of misfiring of sustain discharge in the sustain period can be prevented. The VscL2 voltage may vary depending on circumstances of the plasma display device. In order to prevent a turn-off discharge cell from being discharged when the accumulated driving time of the plasma display device increases, the VscL2 voltage is set to be greater than the discharge firing voltage Vfay according to the second exemplary embodiment of the present invention.

According to the above described embodiments, a sustain pulse voltage supplied to a scan electrode is increased during an address period of a subfield as an elapsed driving time of the plasma display device increases, thereby generating a stable address discharge and preventing sustain discharge misfiring.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a plasma display device by a plurality of weighted subfields divided from a frame, the plasma display device having a first electrode, a second electrode, and a third electrode arranged in a direction crossing the first and second electrodes, the method comprising:
accumulating an elapsed driving time of the plasma display device and calculating an accumulated driving time;
comparing the accumulated driving time with a predetermined reference time; and
supplying a sustain pulse having a first voltage to the first electrode during a first period which is an address period of each subfield in response to the accumulated driving time being less than the reference time, and supplying a sustain pulse having a second voltage that is greater than the first voltage to the first electrode during a second period which is an address period of each subfield in response to the accumulated driving time being greater than the reference time.

2. The method of claim 1, further comprising supplying an address pulse having a third voltage that is greater than the second voltage to the third electrode during the first and second periods.

3. The method of claim 2, wherein a difference between the first voltage and the third voltage is greater than a difference between the second voltage and the third voltage.

4. The method of claim 2, wherein an address discharge is generated between the first electrode supplied with the sustain pulse of the first voltage and the third electrode supplied with the address pulse of the third voltage during the first period.

5. The method claim 2, wherein an address discharge is generated between the first electrode supplied with the sustain pulse of the second voltage and the third electrode supplied with the address pulse of the third voltage during the second period.

6. The method of claim 1, wherein a voltage of the first electrode is gradually decreased from a fifth voltage that is greater than a fourth voltage that is greater than the second voltage to a sixth voltage that is less than the fourth voltage while the fourth voltage is supplied to the third electrode during a reset period of the each subfield.

7. The method claim 6, wherein a difference between the sixth voltage and the first voltage is greater than a difference between the sixth voltage and the second voltage.

8. A plasma display device driven by a plurality of subfields divided from a frame, the plasma display device comprising:
a Plasma Display Panel (PDP) having a plurality of first electrodes, a plurality of second electrodes, a plurality of third electrodes crossing the first and second electrodes, and a plurality of discharge cells including the first to third electrodes;
a driver to supply a scan pulse and an address pulse to the plurality of discharge cells for an address discharge in the plurality of subfields; and
a controller to accumulate an elapsed driving time of the PDP and to calculate an accumulated driving time, to control a sustain pulse having a first voltage to be supplied to the first electrode during a first period which is an address period of each subfield in response to the accumulated driving time being less than a predetermined reference time, and to control a sustain pulse having a second voltage that is greater than the first voltage to be supplied to the first electrode during a second period which is an address period of each subfield in response to the accumulated driving time being greater than the reference time.

9. The plasma display device of claim 8, wherein the controller controls an address pulse having a third voltage that is greater than the second voltage to be supplied to the third electrode during the first and second periods.

10. The plasma display device of claim 9, wherein a difference between the first voltage and the third voltage is greater than a difference between the second voltage and the third voltage.

11. The plasma display device of claim 9, wherein an address discharge is generated between the first electrode supplied with the sustain pulse of the first voltage and the third electrode supplied with the address pulse of the third voltage during the first period.

12. The plasma display device of claim 9, wherein an address discharge is generated between the first electrode supplied with the sustain pulse of the second voltage and the third electrode supplied with the address pulse of the third voltage during the second period.

13. The plasma display device of claim 8, wherein the controller controls a voltage of the first electrode to be gradually decreased from a fifth voltage to a sixth voltage while a fourth voltage that is greater than the second voltage is supplied to the third electrode during a reset period of the each subfield, the fifth voltage being greater than the fourth voltage and the sixth voltage being greater than the fourth voltage.

14. The plasma display device of claim 13, wherein a difference between the sixth voltage and the first voltage is greater than a difference between the sixth voltage and the second voltage.
